(19) United States
(12) Patent Application Publication
(10) Pub. No.: US 2021/0390409 A1
(43) Pub. Date: Dec. 16, 2021

(54) TRAINING REINFORCEMENT LEARNING AGENTS USING AUGMENTED TEMPORAL DIFFERENCE LEARNING

(71) Applicant: Google LLC, Mountain View, CA (US)

(72) Inventors: Matthieu Florent Geist, Ancy-Dornot (FR); Nino Vieillard, Paris (FR); Olivier Claude Pietquin, Lille (FR)

(21) Appl. No.: 17/347,264

(22) Filed: Jun. 14, 2021

Related U.S. Application Data
(60) Provisional application No. 63/038,716, filed on Jun. 12, 2020.

(51) Int. Cl. G06N 3/08; G06N 3/04

(52) U.S. Cl. CPC G06N 3/08; G06N 3/04

(57) ABSTRACT

Methods, systems, and apparatus, including computer programs encoded on computer storage media, for training a neural network used to select actions performed by an agent interacting with an environment by performing actions that cause the environment to transition states. One of the methods includes training the neural network on one or more transitions selected from a replay memory, including: generating, using the neural network, an action selection output for the current observation; determining, based on the action selection output and the current action performed by the agent in response to the current observation, a state-action target for the current observation; determining a gradient of a temporal difference (TD) loss function with respect to parameters of the neural network, wherein the TD loss function comprises a first term that depends on the state-action target for the current observation; and adjusting current parameter values of the neural network based on the gradient.

### CROSS-REFERENCE TO RELATED APPLICATION

This application claims priority to U.S. Provisional Application No. 63/038,716, filed on Jun. 12, 2020. The disclosure of the prior application is considered part of and is incorporated by reference in the disclosure of this application.

### BACKGROUND

This specification relates to reinforcement learning.

In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that controls an agent using a control neural network system to perform one or more tasks.

In general, one innovative aspect of the subject matter described in this specification can be embodied in a method for training a neural network used to select actions performed by a reinforcement learning agent interacting with an environment by performing actions that cause the environment to transition states, the method comprising: maintaining a replay memory, the replay memory storing a plurality of transitions generated as a result of the reinforcement learning agent interacting with the environment, each transition comprising a respective current observation characterizing a respective current state of the environment, a respective current action performed by the agent in response to the current observation, a respective next observation characterizing a respective next state of the environment, and a reward received in response to the agent performing the current action; selecting one or more transitions from the replay memory; and training the neural network on the one or more transitions, comprising, for each transition of the one or more transitions: generating, using the neural network, an action selection output for the current observation that defines a probability distribution over a set of possible actions that can be performed by the agent in response to the current observation; determining, based on the action selection output and the current action performed by the agent in response to the current observation, a state-action target for the current observation included in the transition; determining a gradient of a temporal difference (TD) loss function with respect to parameters of the neural network, wherein the TD loss function comprises a first term that depends on the state-action target for the current observation and a second term that depends on a TD learning target for the transition; and adjusting current parameter values of the neural network based on the gradient.

The neural network may be configured to process the current observation and each action in a set of possible actions to output a respective Q value for the action that is an estimate of a return that would be received if the agent performed the action in response to the current observation. Generating the action selection output may comprise generating, from the respective Q values for the actions in the set of possible actions, the probability distribution that assigns a respective probability to each action.

The state-action target may be based on a probability assigned to the current action according to the probability distribution defined by the action selection output.

The first term of the TD loss function that depends on the state-action target may be of form α log A, where A may be the probability assigned to the current action according to the probability distribution defined by the action selection output generated by the neural network based on processing the current observation and each action in the set of possible actions, and a may be a tunable parameter.

Determining the second term that depends on the TD learning target for the transition may comprise: processing the next observation and each action in a set of possible next actions that can be performed by the agent in response to the next observation using the neural network to generate a respective Q value for the next action that is an estimate of a return that would be received if the agent performed the next action in response to the next observation; and generating, from the respective Q values for the set of possible next actions, an action selection output for the next observation defining a probability distribution that assigns a respective probability to each next action.

Determining the second term that depends on the TD learning target for the transition may comprise computing a sum of (i) the reward included in the transition and (ii) a time-adjusted next expected return if a next action is performed in response to the next observation included in the transition.

The time-adjusted next expected return may comprise a weighted sum of estimated returns that would be received by the agent if the agent performed each next action from the set of possible next actions in response to the next observation included in the transition, where respective weights of the estimated returns are determined according to the respective probabilities assigned to the set of possible next actions.

The next expected return may depend at least on an entropy of the action selection output for the next observation.

The time-adjusted next expected return may comprise a weighted sum of entropy-adjusted estimated returns that would be received by the agent if the agent performed each next action from the set of possible next actions in response to the next observation included in the transition.

The TD loss function may measure a difference between (i) a sum of the first term that depends on the state-action target for the current observation and the second term that depends on the TD learning target for the transition and (ii) a Q value for the current action included in the transition.

The method may further comprise determining whether a norm of the first term of the TD loss function that depends on the state-action target exceeds a particular threshold; and when the norm of the first term of the TD loss function exceeds the particular threshold: clipping the first term of the TD loss function to equal to the particular threshold.

Generating the current action selection output may comprise: processing, using a target instance of the neural network and in accordance with target parameter values of the neural network, the current observation and each action in the set of possible actions to output the respective Q value for the action that is the estimate of the return that would be received if the agent performed the action in response to the current observation.

Another innovative aspect of the subject matter described in this specification can be embodied in a method comprising receiving a new observation characterizing a new state of the environment being interacted with by the agent; processing the new observation and each action in a set of possible actions that can be performed by the agent in response to the new observation using a neural network to generate a respective Q value for the action that is an estimate of a return that would be received if the agent performed the action in response to the new observation, wherein the neural network has been trained using the method of any preceding method; selecting, from the set of possible actions, an action based on the respective Q values; and causing the agent to perform the selected action.

Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

Particular embodiments of the subject matter described in this specification can be implemented so as to realize one or more of the following advantages.

The disclosed technique allows for training data from a replay memory to be utilized in a way that increases the value of the selected data for training a neural network used in selecting actions to be performed by agents. In particular, this technique augments a temporal difference (TD) learning target conventionally used in computing a loss function for training the neural network with an additional component that depends on a quality of a currently selected action, e.g., in terms of currently estimated returns (i.e., estimated returns determined by using the neural network in accordance with current values of the network parameters as of the training) to be received by the agent as a result of performing the currently selected action at the current state of the environment. Training neural network using this technique thus provides the neural network with richer training signals that come from the evaluation of the current action selection policy adopted by the system, i.e., as of the training stage. Compared with conventional TD training schemes, neural networks can perform more useful generalizations from training data to generate higher quality action selection outputs that can improve the returns resulting from the agent performing these selected actions.

This can, in turn, increase the effectiveness, efficiency, or both of training of neural networks used in selecting actions to be performed by agents. Thus, the amount of computing resources necessary for the training of the neural networks to achieve a desired level of performance can be reduced. For example, the amount of time required for training the neural network can be reduced, the amount of processing resources (e.g., memory, computing power, or both) used by the training process can be reduced, or both. The increased effectiveness in training of neural networks can be especially significant for complex neural networks that are harder to train or for training neural networks to select actions to be performed by agents performing complex reinforcement learning tasks.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example reinforcement learning system.

FIG. 2 is a flow diagram of an example process for training an action selection neural network.

FIG. 3 is a flow diagram of an example process for evaluating a temporal difference (TD) loss function for use in training an action selection neural network.

Like reference numbers and designations in the various drawings indicate like elements.

### DETAILED DESCRIPTION

This specification describes a reinforcement learning system that controls an agent interacting with an environment by, at each of multiple time steps, processing data characterizing the current state of the environment at the time step (i.e., an “observation”) to select an action to be performed by the agent.

At each time step, the state of the environment at the time step depends on the state of the environment at the previous time step and the action performed by the agent at the previous time step.

In some implementations, the environment is a real-world environment and the agent is a mechanical agent interacting with the real-world environment, e.g., a robot or an autonomous or semi-autonomous land, air, or sea vehicle navigating through the environment.

In these implementations, the observations may include, e.g., one or more of: images, object position data, and sensor data to capture observations as the agent interacts with the environment, for example sensor data from an image, distance, or position sensor or from an actuator.

For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot.

In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations.

The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control inputs to control the robot, e.g., torques for the joints of the robot or higher-level control commands, or the autonomous or semi-autonomous land, air, sea vehicle, e.g., torques to the control surface or other control elements e.g., steering control elements of the vehicle, or higher-level control commands.

In other words, the actions can include for example, position, velocity, or force/torque/acceleration data for one or more joints of a robot or parts of another mechanical agent. Action data may additionally or alternatively include electronic control data such as motor control data, or more generally data for controlling one or more electronic devices within the environment the control of which has an effect on the observed state of the environment. For example in the case of an autonomous or semi-autonomous land or air or sea vehicle the actions may include actions to control navigation e.g., steering, and movement e.g., braking and/or acceleration of the vehicle.

In the case of an electronic agent the observations may include data from one or more sensors monitoring part of a plant or service facility such as current, voltage, power, temperature and other sensors and/or electronic signals representing the functioning of electronic and/or mechanical items of equipment. For example the real-world environment may be a manufacturing plant or service facility, the observations may relate to operation of the plant or facility, for example to resource usage such as power consumption, and the agent may control actions or operations in the plant/facility, for example to reduce resource usage. In some other implementations the real-world environment may be a renewal energy plant, the observations may relate to operation of the plant, for example to maximize present or future planned electrical power generation, and the agent may control actions or operations in the plant to achieve this.

In some other applications the agent may control actions in a real-world environment including items of equipment, for example in a data center, in a power/water distribution system, or in a manufacturing plant or service facility. The observations may then relate to operation of the plant or facility. For example the observations may include observations of power or water usage by equipment, or observations of power generation or distribution control, or observations of usage of a resource or of waste production. The actions may include actions controlling or imposing operating conditions on items of equipment of the plant/facility, and/or actions that result in changes to settings in the operation of the plant/facility e.g., to adjust or turn on/off components of the plant/facility.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In some implementations the environment may be a simulated environment and the agent may be implemented as one or more computers interacting with the simulated environment.

The simulated environment may be a motion simulation environment, e.g., a driving simulation or a flight simulation, and the agent may be a simulated vehicle navigating through the motion simulation. In these implementations, the actions may be control inputs to control the simulated user or simulated vehicle.

In some implementations, the simulated environment may be a simulation of a particular real-world environment. For example, the system may be used to select actions in the simulated environment during training or evaluation of the control neural network and, after training or evaluation or both are complete, may be deployed for controlling a real-world agent in the real-world environment that is simulated by the simulated environment. This can avoid unnecessary wear and tear on and damage to the real-world environment or real-world agent and can allow the control neural network to be trained and evaluated on situations that occur rarely or are difficult to re-create in the real-world environment.

Generally, in the case of a simulated environment, the observations may include simulated versions of one or more of the previously described observations or types of observations and the actions may include simulated versions of one or more of the previously described actions or types of actions.

Optionally, in any of the above implementations, the observation at any given time step may include data from a previous time step that may be beneficial in characterizing the environment, e.g., the action performed at the previous time step, the reward received at the previous time step, and so on.

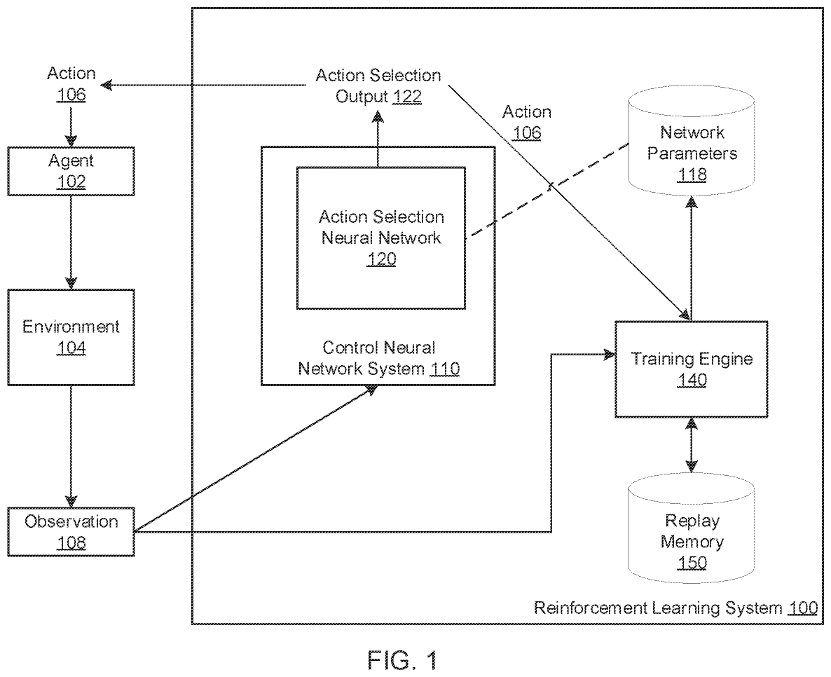

FIG. 1 shows an example reinforcement learning system 100. The reinforcement learning system 100 is an example of a system implemented as computer programs on one or more computers in one or more locations in which the systems, components, and techniques described below are implemented.

The system 100 controls an agent 102 interacting with an environment 104 by selecting actions 106 to be performed by the agent 102 and then causing the agent 102 to perform the selected actions 106.

Performance of the selected actions 106 by the agent 102 generally causes the environment 104 to transition into new states. By repeatedly causing the agent 102 to act in the environment 104, the system 100 can control the agent 102 to complete a specified task.

The system 100 includes a control neural network system 110 which includes an action selection neural network 120, a training engine 140, and one or more memories storing the parameters of the control neural network system 110, including a set of network parameters 118 of the action selection neural network 120.

At each of multiple time steps, the action selection neural network 120 is configured to process an input that includes the current observation 108 characterizing the current state of the environment 104 in accordance with the network parameters 118 to generate an action selection output 122.

The action selection neural network 120 can be implemented with any appropriate neural network architecture that enables it to perform its described function. In one example, the action selection neural network 120 may include a sequence of one or more convolutional layers, followed by a sequence of one or more fully connected layers associated with an activation layer (e.g., a ReLU activation layer), and an output layer that generates the action selection output 122.

The system 100 uses the action selection output 122 to control the agent, i.e., to select the action 106 to be performed by the agent at the current time step in accordance with an action selection policy and then cause the agent to perform the action 106, e.g., by directly transmitting control signals to the agent or by transmitting data identifying the action 106 to a control system for the agent.

In response to some or all of the actions performed by the agent 102, the reinforcement learning system 100 receives a reward. Each reward is a numeric value received from the environment 104 as a consequence of the agent performing an action, i.e., the reward will be different depending on the state that the environment 104 transitions into as a result of the agent 102 performing the action.

A few examples of using the action selection output 122 to select the action 106 to be performed by the agent are described next.

In one example, the action selection output 122 may include a respective Q value for each action in the set of possible actions a E A that can be performed by the agent.

The Q value for an action is an estimate of a “return” that would result from the agent performing the action in response to the current observation 120 and thereafter selecting future actions performed by the agent 102 in accordance with current values of the control neural network parameters.

A return refers to a cumulative measure of reward received by the system 100 as the agent 104 interacts with the environment 106 over multiple time steps. For example, a return may refer to a long-term time-discounted cumulative reward received by the system 100.

As described above, the agent can receive a respective reward at each time step, where the reward is specified by a scalar numerical value and characterizes, e.g., a progress of the agent towards completing a specified task.

In another example, the action selection output 122 may include a respective advantage value for each action in the set of possible actions that can be performed by the agent, which is a measure of how much is a possible action a good or bad decision given a current state—or more simply, what is the advantage of selecting a particular action for the current state over other possible actions. Advantage values may differ from Q values for small time steps in that the differences between advantage values in a given state are larger than the differences between Q values.

In either example, the system 100 can select the action to be performed by the agent based on the action selection output 122 using any of a variety of action selection policies, e.g., by selecting the action with the highest Q value or advantage value, or by mapping the Q values or advantage values to probabilities and sampling an action in accordance with the probabilities. In some cases, the system 100 can select the action to be performed by the agent in accordance with an exploration policy. For example, the exploration policy may be an ϵ-greedy exploration policy, where the system 100 selects the action to be performed by the agent in accordance with the action selection output 122 with probability 1-ϵ, and randomly selects the action with probability ϵ. In this example, ϵ is a scalar value between 0 and 1.

In yet another example, the action selection output 122 may include an estimated quantile value for a probability value (each of which can be a number in the range [0,1]) with respect to a probability distribution over possible returns that would result from the agent performing the action in response to the observation. The quantile value for a probability value with respect to a return distribution refers to a threshold return value below which random draws from the return distribution would fall with probability given by the probability value. Put another way, the quantile value for a probability value with respect to a return distribution can be obtained by evaluating the inverse of the cumulative distribution function (CDF) for the return distribution at the probability value. That is, integrating a probability density function for a return distribution up to the quantile value for a probability value would yield the probability value itself.

In this example, for each given action from the set of possible actions that can be performed by the agent 102, the system 100 randomly samples one or more probability values and, for each probability value, generates an estimated quantile value for the probability value with respect to the return distribution that would result from the agent performing the given action in response to the current observation. For each action, the system 100 determines a corresponding measure of central tendency (where a “measure of central tendency” is a single value that attempts to describe a set of data by identifying a central position within that set of data, i.e., a central or typical value) of the respective set of one or more quantile values for the action. For example, the measure of central tendency may be a mean, a median, or a mode.

The system 100 selects an action 106 to be performed by the agent 102 at the time step based on the measures of central tendency corresponding to the actions. In some implementations, the system 100 selects an action having a highest corresponding measure of central tendency from amongst all the actions in the set of actions that can be performed by the agent 102. In some implementations, the system 100 selects an action in accordance with an exploration strategy. For example, the system 100 may use an ϵ-greedy exploration strategy. In this example, the system 100 may select an action having a highest corresponding measure of central tendency with probability 1-ϵ, and select an action randomly with probability ϵ, where ϵ is a number between 0 and 1.

The training engine 140 is configured to train the action selection neural network system 120 included in the control neural network system 110 by repeatedly updating the network parameters 118 of the action selection neural network system 120 based on the interactions of the agent with the environment. This can allow for the agent 106 to more effectively interact with the environment 104.

To assist in the training of the action selection neural network 120, the training engine 140 maintains a replay memory 150 that is accessible to the system.

The replay memory 150 stores pieces of experience data (referred to below as “transitions”) generated as a consequence of the interaction of the agent 102 or another agent with the environment 104 or with another instance of the environment for use in training the action selection network 120.

The training engine 140 trains the action selection neural network 120 by repeatedly selecting the transitions from the replay memory 150 and training the action selection neural network 120 on the selected transitions. In particular, the training engine performs the training using an augmented temporal difference learning scheme.

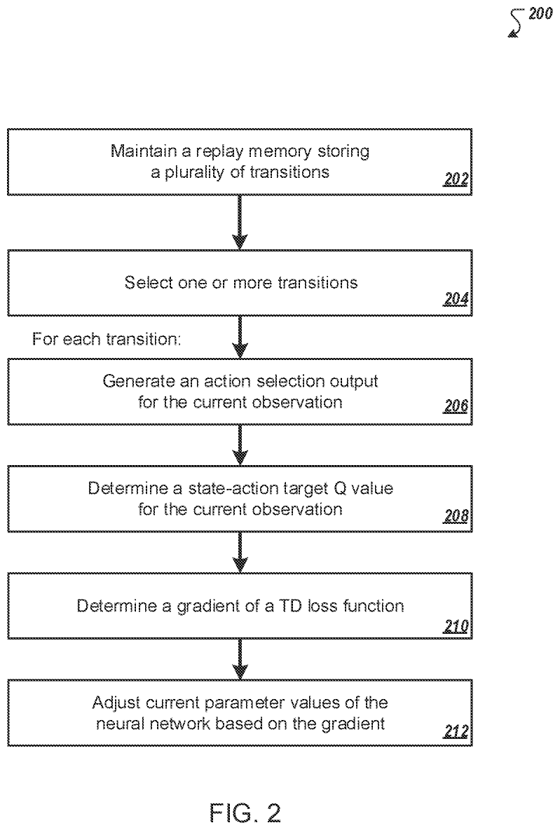

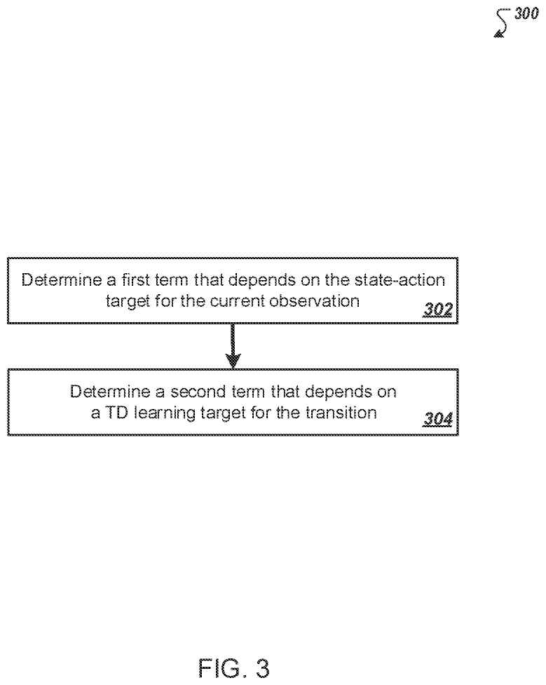

The augmented TD learning training of the system will be described further below with reference to FIGS. 2 and 3, but in short, the system evaluates a TD loss function that includes a first term that depends on the state-action target for the current observation and a second term that depends on a temporal difference learning target for the transition. The incorporation of the state-action target as an additional component in the TD loss function extends the effectiveness of conventional temporal difference learning training scheme which merely considers a standard temporal difference learning target, i.e., which merely involves computing a sum of: (a) a time-discounted next expected return if a next action is performed in response to the next observation in the transition and (b) the reward in the transition.

FIG. 2 is a flow diagram of an example process 200 for training an action selection neural network. For convenience, the process 200 will be described as being performed by a system of one or more computers located in one or more locations. For example, a system, e.g., the reinforcement learning system 100 of FIG. 1, appropriately programmed, can perform the process 200.

The system maintains a replay memory (202). As described above, the replay memory stories a plurality of transitions generated as a result of the reinforcement learning agent (or another agent) interacting with the environment (or with another instance of the environment).

In some implementations, each transition is a tuple that includes: (1) a current observation sₜ characterizing the current state of the environment at one time; (2) a current action αₜ performed by the agent in response to the current observation; (3) a next observation sₜ₊₁ characterizing the next state of the environment after the agent performs the current action, i.e., a state that the environment transitioned into as a result of the agent performing the current action; and (4) a reward rₜ received in response to the agent performing the current action.

The system selects one or more transitions from the replay memory (204). The system can select a transition either randomly or according to a prioritized strategy, e.g., based on the value of an associated temporal difference learning error or some other learning progress measure.

To train the action selection neural network on the one or more transitions, the system can repeatedly perform the followings steps 206-212 for each transition of the one or more transitions.

The system generates, using the action selection neural network, an action selection output for the current observation (206).

In some implementations, the action selection neural network is configured to process the current observation and each action in a set of possible actions to output a respective Q value for the action that is an estimate of a return that would be received if the agent performed the action in response to the current observation. Alternatively, in some other implementations, the action selection neural network is configured to process the current observation and each action in a set of possible actions to output a respective advantage value for the action that is a measure of an advantage, i.e., in terms of a return, of selecting the action over other possible actions in response to the current observation.

In these implementations, the system can generate the action selection output by mapping the respective Q values or advantage values for the actions in the set of possible actions to the probability distribution that defines a probability distribution over a set of possible actions that can be performed by the agent in response to the current observation, i.e., assigns a respective probability to each possible action.

In some implementations, the action selection neural network is configured to process an input tuple including (i) an action from the set of possible actions that can be performed by the agent, (ii) a current observation, and (iii) a probability value (which can be a number in the range [0,1]). The system can use the action selection neural network to process the input tuple to generate an action selection output that includes an estimated quantile value for the probability value with respect to a probability distribution over possible returns that would result from the agent performing the action in response to the observation.

In some such implementations, rather than processing an action—observation—probability value tuple, the action selection neural network may be configured to process an observation—probability value tuple (i.e., without the action). In these implementations, the system can use the action selection neural network to process the input tuple to generate an action selection output that includes respective estimated quantile values for the probability value with respect to the respective return distributions that would result from the agent performing each action in a set of possible actions in response to the observation.

The system determines, based on the action selection output and the current action performed by the agent in response to the current observation, a state-action target for the current observation included in the transition (208). For example, in cases where the (output layer of the) action selection neural network directly parameterizes a probability distribution, the state-action target can be dependent on a probability assigned to the current action according to the probability distribution defined by the action selection output. Alternatively, the system can map the action selection output to a probability distribution over a set of possible actions and thereafter determine the state-action target. For example, the probability distribution can be determined from the respective Q values or advantage values generated for the actions in the set of possible actions, e.g., by processing the Q values or advantage values using a softmax function. As another example, the probability distribution can be determined from the estimated quantile values for the probability value with respect to the respective return distributions generated for the actions in the set of possible actions.

The system determines a gradient of a temporal difference (TD) loss function with respect to parameters of the action selection neural network (210). That is, the system first evaluates a temporal difference (TD) loss function, and then determines, e.g., through backpropagation, a gradient of the TD loss function with respect to the action selection network parameters.

Evaluating the TD loss function will be further described below with reference to FIG. 3, but in short, the TD loss function includes a first term that depends on the state-action target for the current observation and a second term that depends on a temporal difference learning target for the transition.

The system adjusts current parameter values of the action selection neural network based on the gradient (212). The system can adjust the current parameter values of the action selection neural network by applying an update rule to gradient, e.g., a stochastic gradient descent update rule, an Adam optimizer update rule, an rmsProp update rule, or a learned update rule that is specific to the training of the action selection neural network.

FIG. 3 is a flow diagram of an example process 300 for evaluating a temporal difference (TD) loss function for use in training an action selection neural network. For convenience, the process 300 will be described as being performed by a system of one or more computers located in one or more locations. For example, a system, e.g., the reinforcement learning system 100 of FIG. 1, appropriately programmed, can perform the process 300.

The system determines a first term that depends on the state-action target for the current observation (302).

In some implementations, the first term of the TD loss function that depends on the state-action target is of form α log A, where A is the probability assigned to the current action according to the probability distribution defined by the action selection output generated by the action selection neural network based on processing the current observation and each action in the set of possible actions, and α is a tunable parameter which may be computed as a product of a scaling factor α (the value of which can be in the range [0, 1], e.g., 0.9) and a temperature parameter τ (the value of which can be any positive number, e.g., 0.03).

For example, the system can determine the first term as α ln π_{θ}(αₜ|sₜ), where π_{θ}(αₜ|sₜ) is the probably assigned to action αₜ by the probability distribution conditioned on the current observation in the transition, as generated by the system from the Q value outputs of the neural network in accordance with current values of the network parameters θ.

In some implementations, the system can require the value of the first term of the TD loss function that depends on the state-action target to be within a bounded range, so as to alleviate any numerical issues that would otherwise arise in cases where the action selection output becomes too deterministic. For example, the system can determine whether a norm of the first term exceeds a particular threshold l₀ and, whenever the norm of the first term of the TD loss function exceeds the particular threshold, the system clips the first term of the TD loss function to equal to the particular threshold. For example, the particular threshold can be a positive integer, e.g., one.

The system determines a second term that depends on a TD learning target for the transition (304). The TD learning target for the transition can be a sum of (i) the reward included in the transition and (ii) a time-adjusted next expected return if a next action is performed in response to the next observation included in the transition.

The manner in which the system selects the next action α′ and determines the next expected return is dependent on the reinforcement learning algorithm being used to train the neural network. For example, in a deep Q learning technique, the system selects as the next action the action that, when provided as input to a target neural network in combination with the next observation, results in the target neural network outputting the highest Q value and uses the Q value for the next action that is generated by the target neural network as the next return. As another example, in a double deep Q learning technique, the system selects as the next action the action that, when provided as input to the neural network in combination with the next observation, results in the target neural network outputting the highest Q value and uses the Q value generated by providing the next action and the next observation as input to the target neural network as the next return. The target neural network is another instance of the neural network that has the same architecture as the action selection neural network, but that may have different parameter values.

In either example, the time-adjusted next expected return can be alternatively computed as a weighted sum of estimated returns that would be received by the agent if the agent performed each next action from the set of possible next actions in response to the next observation included in the transition, where respective weights of the estimated returns are determined according to the respective probabilities assigned to the set of possible next actions, which may include a non-zero value (e.g., one) to the selected next action and zero values to the remaining actions from the set of possible next actions.

In other words, to determine the second term that depends on the TD learning target for the transition, the system can process the next observation and each action in a set of possible next actions that can be performed by the agent in response to the next observation using the neural network (or the target instance of the neural network) to generate a respective Q value for the next action that is an estimate of a return that would be received if the agent performed the next action in response to the next observation. The system then generates, from the respective Q values for the set of possible next actions, an action selection output for the next observation defining a probability distribution that assigns a respective probability to each next action.

In some implementations, the time-adjusted next expected return included in the TD learning target depends on an entropy of the action selection output for the next observation, i.e., also includes a weighted sum of entropy-adjusted estimated returns that would be received by the agent if the agent performed each next action from the set of possible next actions in response to the next observation included in the transition. The entropy, which can be computed as π_{θ} (α′|sₜ₊₁), may be scaled by the temperature parameter τ the value of which can be any positive number, e.g., 0.03.

In the case of Q learning, i.e., in the implementations where the action selection neural network is configured to process the current observation and each action in a set of possible actions to output a respective Q value, the TD loss function can measure a difference between (i) a sum of the first term that depends on the state-action target for the current observation and the second term that depends on the TD learning target for the transition and (ii) a Q value for the current action included in the transition. To determine the Q value for the current action, the system can process an input that includes the current action and the current observation using the action selection neural network in accordance with current values of the action selection network parameters.

In such cases, to determine the sum of the first and second terms of the TD loss function, the system can compute:

$${r}_{t} + {ατln}_{\overline{θ}} ( {a}_{t} \vert {s}_{t} ) + γ {}_{\overline{θ}} ( {a}^{′} \vert {s}_{t + 1} ) ( {q}_{\overline{θ}} ( {s}_{t + 1} , {a}^{′} ) - {τln}_{\overline{θ}} ( {a}^{′} \vert {s}_{t + 1} ) ) , \qquad ( 1 )$$

where the first term is evaluated as ατ ln π_{θ̅}(αₜ|sₜ), with α and τ being the scaling factor and temperature parameter, respectively, and the second term is evaluated as the reward rₜ included in the transition plus the term in the summation operator that is weighted by a time-discounting parameter γ the value of which can be in the range [0, 1], e.g., 0.99.

The first term which is evaluated as a scaled logarithm of the action selection output computed by using the neural network can result in performance improvement of the agent when controlled using the system. This is also very unlike the traditional temporal difference learning training scheme, which may evaluate the TD target for the loss function as:

$${r}_{t} + γ {}_{\overline{θ}} ( {a}^{′} \vert {s}_{t + 1} ) ( {q}_{\overline{θ}} ( {s}_{t + 1} , {a}^{′} ) - {τln}_{\overline{θ}} ( {a}^{′} \vert {s}_{t + 1} ) ) with {}_{\overline{θ}} = sm ( \frac{{q}_{\overline{θ}}}{T} ) , \qquad ( 2 )$$

where sm refer to the softmax operator, and θ and θ̅ refer to current parameter values of the action selection neural network and the target instance of the action selection neural network, respectively, i.e., without evaluating the state-action target for the current observation.

Correspondingly, the system can evaluate the TD loss function as:

$${\hat{𝔼}}_{B} [ h ( {r}_{t} + {α [ {τ ln }_{\overline{θ}} ( {a}_{t} \vert {s}_{t} ) ]}_{{l}_{0}}^{0} + γ {}_{\overline{θ}} ( a \vert {s}_{t + 1} ) ( {q}_{\overline{θ}} ( {s}_{t + 1} , a ) - {τln}_{\overline{θ}} ( a \vert {s}_{t + 1} ) ) - {q}_{θ} ( {s}_{t} , {a}_{t} ) ) ] . \qquad ( 3 )$$

where h the Huber loss function, with a parameter xₕ, h(x)=x² if x<xₕ else |x|.

In the case of advantage learning (as a special case of Q learning where τ=0), i.e., in the implementations where the action selection neural network is configured to process the current observation and each action in a set of possible actions to output a respective advantage value for the action that is a measure of an advantage, the system can evaluate the TD loss function as:

$${\hat{𝔼}}_{B} [ h ( {r}_{t} + α ( {q}_{\overline{θ}} ( {s}_{t} \vert {a}_{t} ) - {max}_{a ∈ 𝒜} {q}_{\overline{θ}} ( {s}_{t} \vert a ) ) + {max}_{α ∈ 𝒜} {q}_{\overline{θ}} ( {s}_{t + 1} , a ) - {q}_{θ} ( {s}_{t} , {a}_{t} ) ) ] , \qquad ( 4 )$$

where the first term that depends on the state-action target for the current observation is computed as

$$α ( {q}_{\overline{θ}} ( {s}_{t} , {a}_{t} ) - {max}_{a ∈ 𝒜} {q}_{\overline{θ}} ( {s}_{t} , a ) ) .$$

In the case of quantile function approximation learning, i.e., in the implementations where the action selection neural network is configured to process an input tuple including (i) an action from the set of possible actions that can be performed by the agent, (ii) a current observation, and (iii) a probability value to output an estimated quantile values for the probability value with respect to the respective return distributions that would result from the agent performing the action in response to the current observation, the system can evaluate the TD loss function by computing an expectation of a Huber loss function applied to a TD error. The TD error can be evaluated as:

$${r}_{t} + {α [ τln ( {a}_{t} \vert {s}_{t} ) ]}_{{l}_{0}}^{0} + γ {\sum }_{a ∈ 𝒜}^{ } ( a \vert {s}_{t + 1} ) ( {z}_{{σ}^{′}} ( {s}_{t + 1} , a ) - τln ( a \vert {s}_{t + 1} ) ) - {z}_{σ} ( {s}_{t} , {a}_{t} ) , \qquad ( 5 )$$

where σ, σ′∈[0,1], and where the return distributions are approximated by using the z-function:

$${z}_{} ( s , a ) = {\sum }_{t = 0}^{∞} {γ}^{t} r ( {s}_{t} , {a}_{t} ) , with {a}_{t} ∼ ( \cdot \vert {s}_{t} ) and {s}_{t + 1} ∼ P ( \cdot \vert {s}_{t} , {a}_{t} ) for {s}_{0} = s and {a}_{0} = a ,$$

from which the Q values may be estimated by computing q_{π}(s,α)= [symbol] [z_{π}(s,α)], e.g., by using Monte Carlo methods. In this case, the first term that depends on the state-action target for the current observation is computed as

$${α [ τln ( {a}_{t} \vert {s}_{t} ) ]}_{{l}_{0}}^{0} .$$

In any of these cases, the system can additionally incorporate n-step bootstrapping methods into the training when evaluating the temporal difference (TD) loss function. In n-step bootstrapping, the system evaluates the TD learning target for a transition over multiple next times steps subsequent to the current time step:

Gₜ⁽ⁿ⁾=rₜ+γrₜ₊₁+ . . . +γⁿ⁻¹rₜ₊ₙ₋₁+γⁿVₜ₊ₙ₋₂(sₜ₊ₙ₋₁),

which is a sum of (i) the current reward rₜ included in the transition and (ii) a time-adjusted next expected return if n next steps are performed, and where n can be any positive integer greater than one, e.g., three. N-step returns can be considered approximations of a full return for an entire episode, truncated after n steps and then corrected for the remaining steps by Vₜ₊ₙ₋₂(rₜ₊ₙ₋₁), i.e., a n-th expected return if a n-th action is performed in response to the n-th observation following the current observation Sₜ included in the transition. In various cases, N-step returns may lead to faster training.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for training a neural network used to select actions performed by a reinforcement learning agent interacting with an environment by performing actions that cause the environment to transition states, the method comprising:
maintaining a replay memory, the replay memory storing a plurality of transitions generated as a result of the reinforcement learning agent interacting with the environment, each transition comprising a respective current observation characterizing a respective current state of the environment, a respective current action performed by the agent in response to the current observation, a respective next observation characterizing a respective next state of the environment, and a reward received in response to the agent performing the current action;
selecting one or more transitions from the replay memory; and
training the neural network on the one or more transitions, comprising, for each transition of the one or more transitions:
generating, using the neural network, an action selection output for the current observation that defines a probability distribution over a set of possible actions that can be performed by the agent in response to the current observation;
determining, based on the action selection output and the current action performed by the agent in response to the current observation, a state-action target for the current observation included in the transition;
determining a gradient of a temporal difference (TD) loss function with respect to parameters of the neural network, wherein the TD loss function comprises a first term that depends on the state-action target for the current observation and a second term that depends on a TD learning target for the transition; and
adjusting current parameter values of the neural network based on the gradient.

2. The method of claim 1, wherein:
the neural network is configured to process the current observation and each action in a set of possible actions to output a respective Q value for the action that is an estimate of a return that would be received if the agent performed the action in response to the current observation; and
generating the action selection output comprises generating, from the respective Q values for the actions in the set of possible actions, the probability distribution that assigns a respective probability to each action.

3. The method of claim 1, wherein the state-action target is based on a probability assigned to the current action according to the probability distribution defined by the action selection output.

4. The method of claim 3, wherein the first term of the TD loss function that depends on the state-action target is of form α log A, where A is the probability assigned to the current action according to the probability distribution defined by the action selection output generated by the neural network based on processing the current observation and each action in the set of possible actions, and α is a tunable parameter.

5. The method of claim 1, wherein determining the second term that depends on the TD learning target for the transition comprises:
processing the next observation and each action in a set of possible next actions that can be performed by the agent in response to the next observation using the neural network to generate a respective Q value for the next action that is an estimate of a return that would be received if the agent performed the next action in response to the next observation; and
generating, from the respective Q values for the set of possible next actions, an action selection output for the next observation defining a probability distribution that assigns a respective probability to each next action.

6. The method of claim 5, wherein determining the second term that depends on the TD learning target for the transition comprises computing a sum of (i) the reward included in the transition and (ii) a time-adjusted next expected return if a next action is performed in response to the next observation included in the transition.

7. The method of claim 6, wherein the time-adjusted next expected return comprises a weighted sum of estimated returns that would be received by the agent if the agent performed each next action from the set of possible next actions in response to the next observation included in the transition, where respective weights of the estimated returns are determined according to the respective probabilities assigned to the set of possible next actions.

8. The method of claim 6, wherein the next expected return depends at least on an entropy of the action selection output for the next observation.

9. The method of claim 6, wherein the time-adjusted next expected return comprises a weighted sum of entropy-adjusted estimated returns that would be received by the agent if the agent performed each next action from the set of possible next actions in response to the next observation included in the transition.

10. The method of claim 1, wherein the TD loss function measures a difference between (i) a sum of the first term that depends on the state-action target for the current observation and the second term that depends on the TD learning target for the transition and (ii) a Q value for the current action included in the transition.

11. The method of claim 1, further comprising:
determining whether a norm of the first term of the TD loss function that depends on the state-action target exceeds a particular threshold; and
when the norm of the first term of the TD loss function exceeds the particular threshold:
clipping the first term of the TD loss function to equal to the particular threshold.

12. The method of claim 1, wherein generating the current action selection output comprises:
processing, using a target instance of the neural network and in accordance with target parameter values of the neural network, the current observation and each action in the set of possible actions to output the respective Q value for the action that is the estimate of the return that would be received if the agent performed the action in response to the current observation.

13. A system comprising one or more computers and one or more storage devices storing instructions that when executed by one or more computers cause the one or more computers to perform operations for training a neural network used to select actions performed by a reinforcement learning agent interacting with an environment by performing actions that cause the environment to transition states, wherein the operations comprise:
maintaining a replay memory, the replay memory storing a plurality of transitions generated as a result of the reinforcement learning agent interacting with the environment, each transition comprising a respective current observation characterizing a respective current state of the environment, a respective current action performed by the agent in response to the current observation, a respective next observation characterizing a respective next state of the environment, and a reward received in response to the agent performing the current action;
selecting one or more transitions from the replay memory; and
training the neural network on the one or more transitions, comprising, for each transition of the one or more transitions:
generating, using the neural network, an action selection output for the current observation that defines a probability distribution over a set of possible actions that can be performed by the agent in response to the current observation;
determining, based on the action selection output and the current action performed by the agent in response to the current observation, a state-action target for the current observation included in the transition;
determining a gradient of a temporal difference (TD) loss function with respect to parameters of the neural network, wherein the TD loss function comprises a first term that depends on the state-action target for the current observation and a second term that depends on a TD learning target for the transition; and
adjusting current parameter values of the neural network based on the gradient.

14. The system of claim 13, wherein:
the neural network is configured to process the current observation and each action in a set of possible actions to output a respective Q value for the action that is an estimate of a return that would be received if the agent performed the action in response to the current observation; and
generating the action selection output comprises generating, from the respective Q values for the actions in the set of possible actions, the probability distribution that assigns a respective probability to each action.

15. The system of claim 13, wherein the state-action target is based on a probability assigned to the current action according to the probability distribution defined by the action selection output.

16. The system of claim 15, wherein the first term of the TD loss function that depends on the state-action target is of form α log A, where A is the probability assigned to the current action according to the probability distribution defined by the action selection output generated by the neural network based on processing the current observation and each action in the set of possible actions, and α is a tunable parameter.

17. The system of claim 13, wherein determining the second term that depends on the TD learning target for the transition comprises:
processing the next observation and each action in a set of possible next actions that can be performed by the agent in response to the next observation using the neural network to generate a respective Q value for the next action that is an estimate of a return that would be received if the agent performed the next action in response to the next observation; and
generating, from the respective Q values for the set of possible next actions, an action selection output for the next observation defining a probability distribution that assigns a respective probability to each next action.

18. The system of claim 17, wherein determining the second term that depends on the TD learning target for the transition comprises computing a sum of (i) the reward included in the transition and (ii) a time-adjusted next expected return if a next action is performed in response to the next observation included in the transition.

19. The system of claim 18, wherein the time-adjusted next expected return comprises a weighted sum of estimated returns that would be received by the agent if the agent performed each next action from the set of possible next actions in response to the next observation included in the transition, where respective weights of the estimated returns are determined according to the respective probabilities assigned to the set of possible next actions.

20. One or more computer-readable storage media storing instructions that when executed by one or more computers cause the one or more computers to perform operations for training a neural network used to select actions performed by a reinforcement learning agent interacting with an environment by performing actions that cause the environment to transition states, wherein the operations comprise:
maintaining a replay memory, the replay memory storing a plurality of transitions generated as a result of the reinforcement learning agent interacting with the environment, each transition comprising a respective current observation characterizing a respective current state of the environment, a respective current action performed by the agent in response to the current observation, a respective next observation characterizing a respective next state of the environment, and a reward received in response to the agent performing the current action;
selecting one or more transitions from the replay memory; and
training the neural network on the one or more transitions, comprising, for each transition of the one or more transitions:
generating, using the neural network, an action selection output for the current observation that defines a probability distribution over a set of possible actions that can be performed by the agent in response to the current observation;
determining, based on the action selection output and the current action performed by the agent in response to the current observation, a state-action target for the current observation included in the transition;
determining a gradient of a temporal difference (TD) loss function with respect to parameters of the neural network, wherein the TD loss function comprises a first term that depends on the state-action target for the current observation and a second term that depends on a TD learning target for the transition; and
adjusting current parameter values of the neural network based on the gradient.
